(19) United States
(12) Patent Application Publication
(10) Pub. No.: US 2023/0208774 A1
(43) Pub. Date: Jun. 29, 2023

(54) PREEMPTION FOR LOW LATENCY APPLICATION

(71) Applicant: Intel Corporation, Santa Clara, CA (US)

(72) Inventors: Juan Fang, Portland, OR (US); Dmitry Akhmetov, Hillsboro, OR (US); Danny Alexander, Neve Efraim Monoson (IL); Laurent Cariou, Milizac (FR); Qinghua Li, San Ramon, CA (US); Minyoung Park, San Ramon, CA (US); Ehud Reshef, Qiryat Tivon (IL); Robert Stacey, Portland, OR (US); Daniel F. Bravo, Portland, OR (US); Cheng Chen, Camas, WA (US); Po-Kai Huang, San Jose, CA (US)

(21) Appl. No.: 18/177,580

(22) Filed: Mar. 2, 2023

Related U.S. Application Data
(60) Provisional application No. 63/437,035, filed on Jan. 4, 2023.

(51) Int. Cl. H04L 47/28; H04L 47/2475; H04L 47/34; H04L 47/24; H04L 47/43

(52) U.S. Cl. CPC H04L 47/28; H04L 47/34; H04L 47/43; H04L 47/245; H04L 47/2475

(57) ABSTRACT

This disclosure describes systems, methods, and devices related to low latency preemption. A device may divide a first PPDU into a plurality of segmented PPDUs. The device may insert a plurality of time gaps between the plurality of segmented PPDUs, wherein the plurality of time gaps enable preemptive opportunities by a low latency transmitter. The device may identify a preemption request from a low latency transmitter of the one or more station devices during a first time gap between a first segmented PPDU and a second segmented PPDU. The device may preempt the second segmented PPDU based on a preemption bit in order to allow the low latency transmitter to transmit its low latency data.

### CROSS-REFERENCE TO RELATED PATENT APPLICATION(S)

This application claims the benefit of U.S. Provisional Application No. 63/437,035, filed Jan. 4, 2023, the disclosure of which is incorporated by reference as set forth in full.

### TECHNICAL FIELD

This disclosure generally relates to systems and methods for wireless communications and, more particularly, to preemption for low latency application.

### BACKGROUND

In today’s fast-paced technological landscape, the need for real-time processing and transmission of data has become increasingly crucial for many industries. The ability to quickly and accurately transmit time-critical information is particularly important in industries such as finance, healthcare, and telecommunications, where even a small delay in transmitting or processing data can have significant consequences.

One significant challenge in achieving low latency data transmission is the occurrence of preemption, which refers to the process of interrupting an ongoing task to perform a higher-priority task. Preemption is necessary to ensure that time-critical information is processed and transmitted as quickly as possible, but it can also introduce significant latency if not managed effectively.

### BRIEF DESCRIPTION OF THE DRAWINGS

FIG. 1 is a network diagram illustrating an example network environment for low latency preemption, in accordance with one or more example embodiments of the present disclosure.

FIGS. 2A-2E depict illustrative schematic diagrams for low latency preemption, in accordance with one or more example embodiments of the present disclosure.

FIGS. 3A-3D depict illustrative schematic diagrams for low latency preemption, in accordance with one or more example embodiments of the present disclosure.

FIGS. 4A-4C depict illustrative schematic diagrams for low latency preemption, in accordance with one or more example embodiments of the present disclosure.

FIGS. 5A-5E depict illustrative schematic diagrams for low latency preemption, in accordance with one or more example embodiments of the present disclosure.

FIGS. 6A-6D depict illustrative schematic diagrams for low latency preemption, in accordance with one or more example embodiments of the present disclosure.

FIGS. 7A-7C depict illustrative schematic diagrams for low latency preemption, in accordance with one or more example embodiments of the present disclosure.

FIGS. 8A-8C depict illustrative schematic diagrams for low latency preemption, in accordance with one or more example embodiments of the present disclosure.

FIG. 9 illustrates a flow diagram of a process for an illustrative low latency preemption system, in accordance with one or more example embodiments of the present disclosure.

FIG. 10 illustrates a functional diagram of an exemplary communication station that may be suitable for use as a user device, in accordance with one or more example embodiments of the present disclosure.

FIG. 11 illustrates a block diagram of an example machine upon which any of one or more techniques (e.g., methods) may be performed, in accordance with one or more example embodiments of the present disclosure.

FIG. 12 is a block diagram of a radio architecture in accordance with some examples.

FIG. 13 illustrates an example front-end module circuitry for use in the radio architecture of FIG. 12, in accordance with one or more example embodiments of the present disclosure.

FIG. 14 illustrates an example radio IC circuitry for use in the radio architecture of FIG. 12, in accordance with one or more example embodiments of the present disclosure.

FIG. 15 illustrates an example baseband processing circuitry for use in the radio architecture of FIG. 12, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

A study group, named Wi-Fi 8 ultra-high reliability study group, has been established with a set of specific objectives. The primary goal of this study group is to enhance the reliability of WLAN connectivity by identifying and resolving issues that can hinder the performance of WLAN connections. Additionally, the group aims to reduce the latency involved in establishing and maintaining WLAN connections, thus improving the overall performance of WLAN networks. Furthermore, the study group intends to increase the manageability of WLAN networks, making them easier to maintain and troubleshoot. Another objective of the group is to increase the throughput of WLAN networks, especially at different SNR levels, which can have a significant impact on network performance. Finally, the study group aims to reduce device-level power consumption, which is a critical consideration for mobile devices and other battery-operated devices that use WLAN connectivity. The Wi-Fi 8 ultra-high reliability study group aims to provide a more reliable and efficient WLAN experience for users by addressing these key areas of concern.Low latency data refers to information that needs to be transmitted, processed, and delivered with minimal delay or latency. In other words, low latency data is time-critical information that needs to be transmitted and received as quickly as possible to achieve a desired outcome.

Low latency applications are becoming increasingly important in today’s fast-paced digital world. Some examples of low latency applications include online gaming, high-frequency trading, video conferencing, autonomous vehicles, and industrial control systems. Online gaming requires low latency to provide an immersive and responsive gaming experience, where even a few milliseconds of delay can affect the gameplay and result in a poor user experience. High-frequency trading also requires low latency to enable traders to make split-second decisions based on market changes, where low latency can translate to significant financial gains or losses. Video conferencing requires low latency to ensure smooth communication between participants without noticeable delays, while autonomous vehicles need low latency to enable real-time processing of sensor data and make split-second decisions on road conditions and obstacles to avoid accidents. Lastly, industrial control systems require low latency to ensure sensors and actuators can communicate in real-time and execute precise control actions, where any delay or inaccuracy in control can result in equipment damage and production loss. Overall, low latency applications are essential in various fields where real-time processing and communication are critical to success, and they require advanced technologies and efficient communication protocols to achieve low latency and high accuracy.

Enabling low latency applications in a heavily loaded 802.11 network while minimizing performance impact to high throughput traffic is a significant challenge. It is a complex problem to solve as it requires reconciling two contradicting needs. On the one hand, there is a need to allow long and efficient transmit opportunities (TXOPs) for high throughput traffic. On the other hand, restricting TXOP limits is necessary for latency reduction. Balancing these two requirements is challenging since high throughput transmissions need long transmission times, while low latency applications require short and predictable transmission times. This problem requires the development of advanced techniques and protocols to optimize the use of the available network resources while still satisfying the requirements of both high throughput and low latency applications. Currently, IEEE 802.11 does not allow the preemption of a transmission.

In case of an AP wants to allow for low latency transmissions, it may limit the maximum TXOP to the latency target, and through that provide opportunities for DL (or UL) transmissions every “T” mSec.

Example embodiments of the present disclosure relate to systems, methods, and devices for preemption for low latency applications.

In one or more embodiments, a low latency preemption system may facilitate preemption indication for using a protocol in the uplink (UL) single user (SU) case while the station device (STA) is the TXOP holder.

In one embodiment, a low latency preemption system may reduce both the average and the worst-case latency for low latency applications in Wi-Fi networks while all the operation channels are being occupied with long TXOP data transmission by other STAs within the BSS at minimum performance impact to the high throughput traffic.

Low/deterministic latency and reliable communications are some of the main gaps in existing Wi-Fi radios (including 802.11be) and they are defined as one of the main targets in next generation Wi-Fi standards, 802.11uhr (Wi-Fi 8). The mechanisms proposed in this disclosure will enable low latency applications in 802.11 networks that are heavily loaded with other clients’ high throughput transmissions to improve latency performance, while at the same time minimizing the performance impact on the high throughput traffic.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

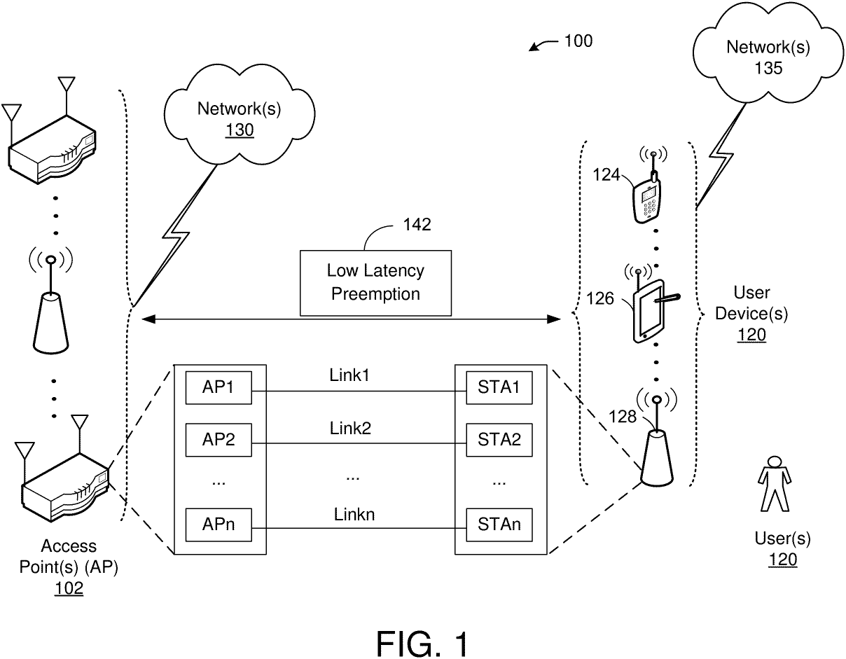

FIG. 1 is a network diagram illustrating an example network environment of low latency preemption, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

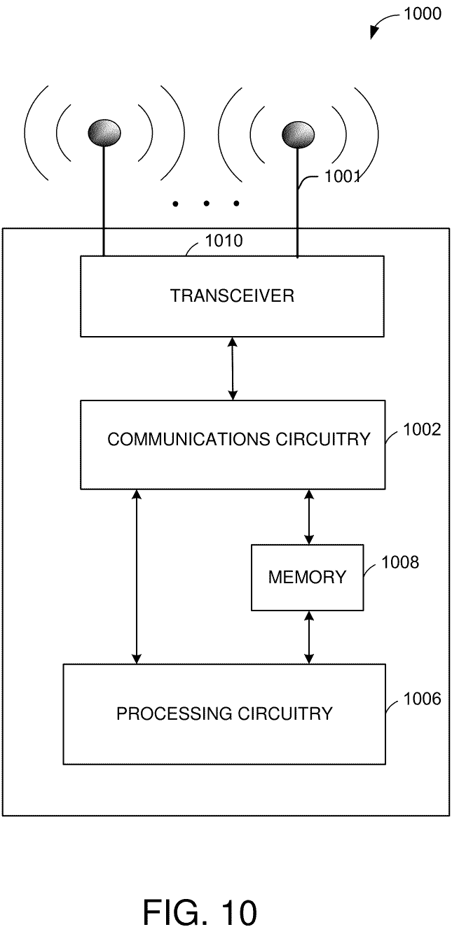

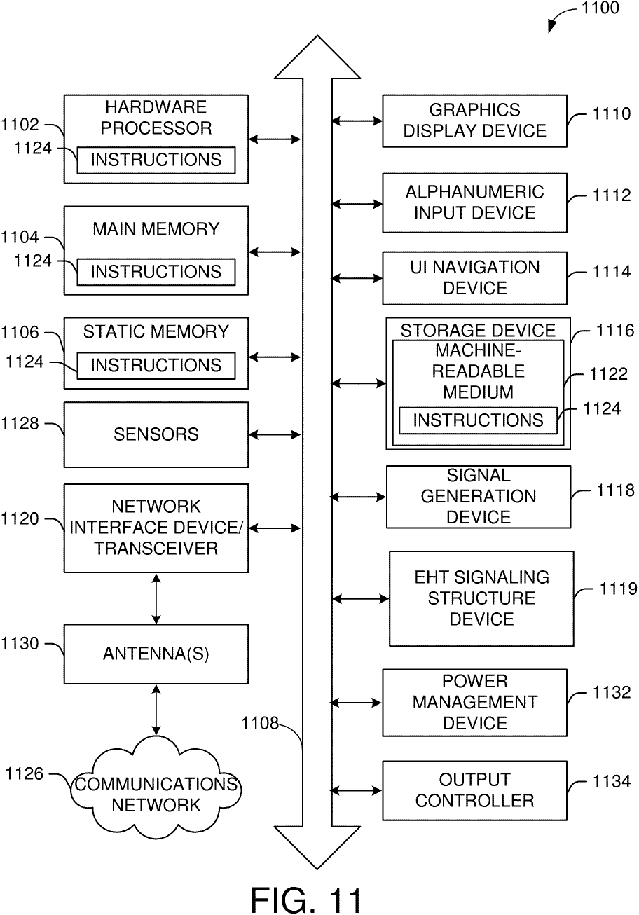

In some embodiments, the user devices 120 and the AP 102 may include one or more computer systems similar to that of the functional diagram of FIG. 10 and/or the example machine/system of FIG. 11.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11 g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement a low latency preemption 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, ..., APn, where n is an integer) and each of the one or more user devices 120 may comprise a plurality of individual STAs (e.g., STA1, STA2, ..., STAn). The AP MLDs and the non-AP MLDs may set up one or more links (e.g., Link1, Link2, ..., Linkn) between each of the individual APs and STAs. It is understood that the above descriptions are for purposes of illustration and are not meant to be limiting.

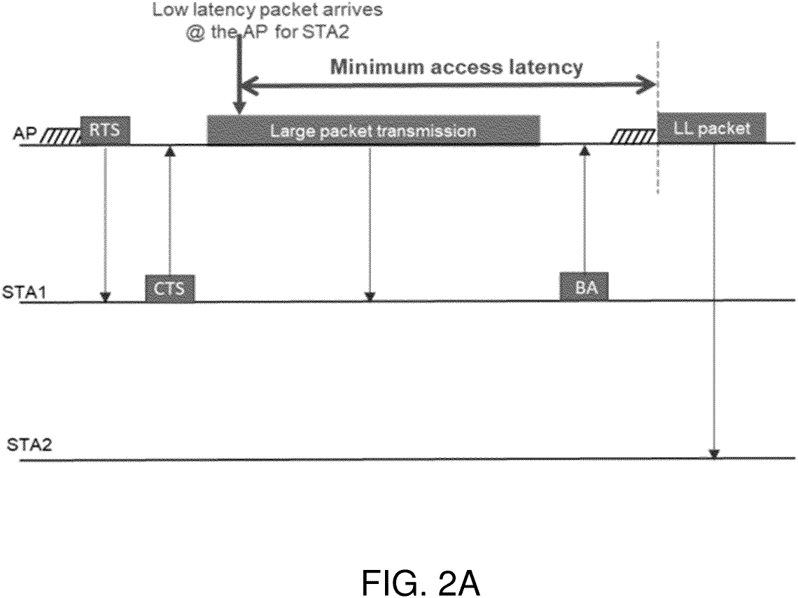

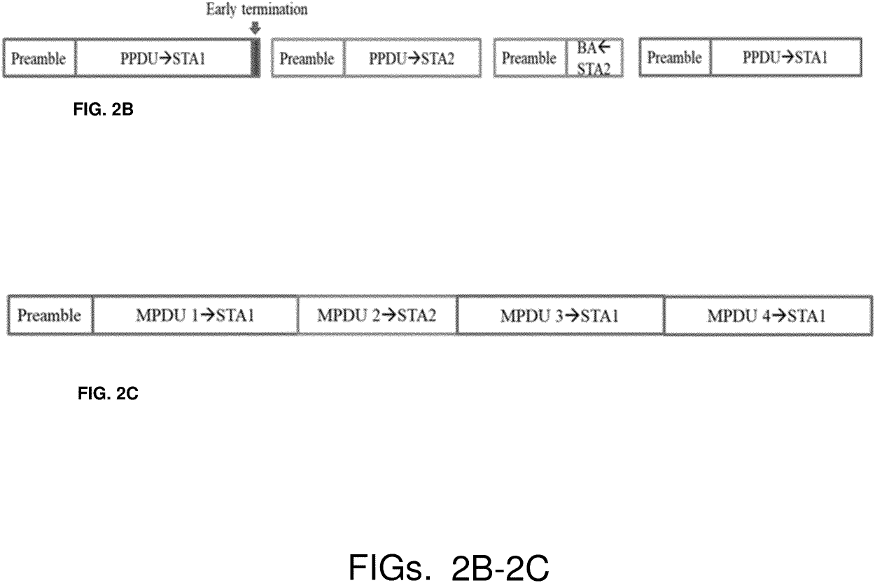

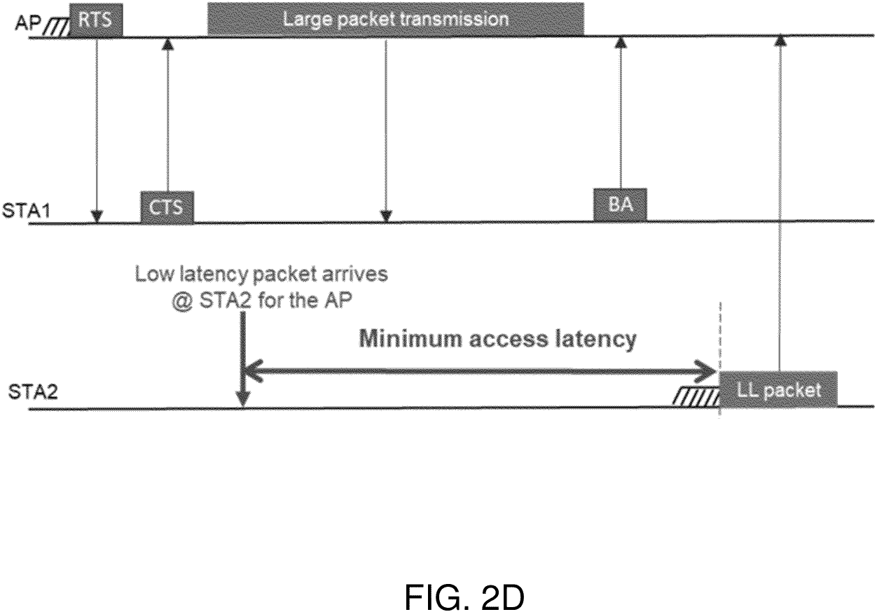

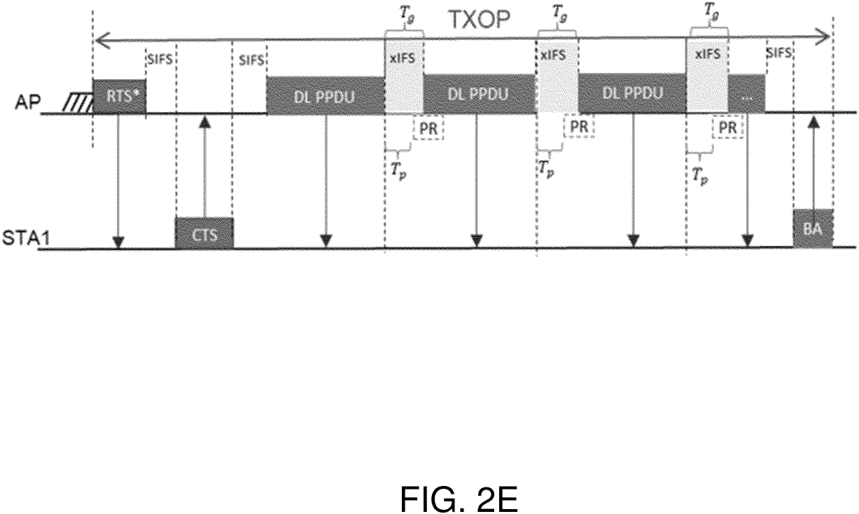

FIGS. 2A-2E depict illustrative schematic diagrams for low latency preemption, in accordance with one or more example embodiments of the present disclosure.

Referring to FIG. 2A, there is shown Case A for low latency (LL) transmitter is the TXOP holder or responder.

As shown in FIG. 2A, once the AP obtained the channel, it can start a long downlink (DL) physical layer (PHY) convergence protocol data unit (PPDU) transmission. If later a LL packet arrives at the AP for another STA, the AP needs to wait until the end of the current DL transmission to send the LL packet, which will lead to a large delay in the LL application.

Referring to FIG. 2B, there is shown OFDM symbol level preemption for LL application.

As shown in FIG. 2B, the TXOP holder or responder can do early termination over the current PPDU transmission and send the LL packet.

Referring to FIG. 2C, there is shown an MPDU level preemption with multiple receiving station address (RA) A-MPDU.

As shown in FIG. 2C, the TXOP holder or responder can insert LL MPDU for another receiver by using multiple RA AMPDU formats.

Referring to FIG. 2D, there is shown in Case B where the low latency transmitter is not the TXOP holder or responder.

As shown in FIG. 2D, if the LL transmitter is not the TXOP holder or responder, it needs to wait until the end of PPDU exchange to access the medium for LL transmission. It is proposed to divide the long data PPDU into multiple small PPDUs with maximum PPDU length limitation with time gaps between two continuous PPDUs to enable preemption opportunity for LL transmission. However, there are still some detailed rules not defined yet, such as which time gaps are preemptable, how to avoid collisions among multiple LL transmitters, and how to support preemption while the LL transmitter is a hidden node to the data PPDU transmitter.

In one or more embodiments, a low latency preemption system may divide or segment the large PPDU into smaller segmented PPDUs with maximum length (of a segment) limitation and time gaps to enable preemption opportunity for LL transmitter.

In one or more embodiments, a low latency preemption system may facilitate that one or more LL transmitters can send a common preemption request (PR) during the time gaps to indicate that it has LL packet to send when the preemption is allowed. This can avoid collision between multiple LL transmitters and also avoid reserving time slot periodically within TXOP for LL traffic. The PR frame can be a short control frame with a receiver address only, such as a CTS frame or a short common waveform, which can be transmitted within T_{g} before the next PPDU. To differentiate which time gap within the TXOP is preemptable or not. A preemption indication is needed in the PPDU preceding the time gap. To prioritize LL transmitter, shorter xIFS (T_{P}) channel access will be used for the LL transmitter (T_{P}) to send common PR compared with the T_{g} for TXOP holder (T_{g}) to send data/TF/BA as shown in FIG. 2E. Note: Tₚ<T_{g}

The PR frame can be sent before the next PPDU sent by the AP to avoid hidden node problem between STAs, which means STA cannot preempt STA directly.

In one or more embodiments, when the AP receives a common PR request, it can use different methods to facilitate the transmission of Low Latency (LL) packets. One way is to trigger the LL Stations (STAs) to provide feedback on their buffer status using a null data packet feedback report poll (NFRP). The AP can then use this information to initiate LL data transmission. Another method involves the AP triggering the LL STAs to send LL packets using OFDMA based random access. Further, the AP can terminate the TXOP early and release the channel for LL transmission using enhanced distributed channel access (EDCA). These methods allow the AP to support LL packet transmission while minimizing the impact on high throughput traffic.

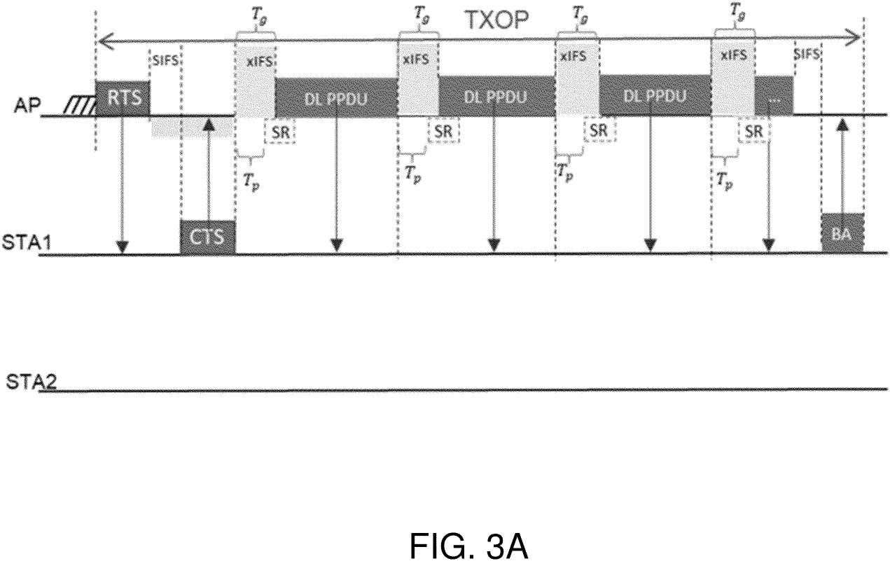

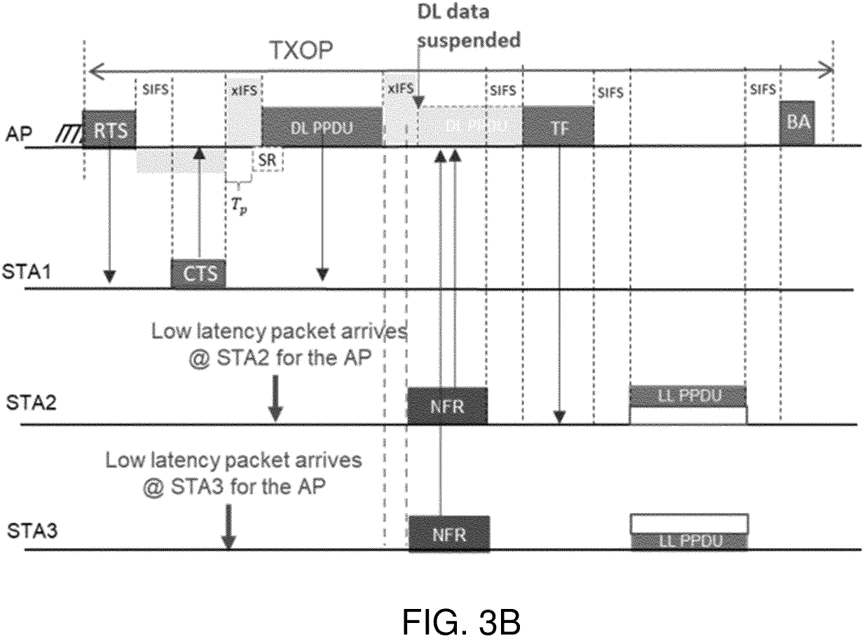

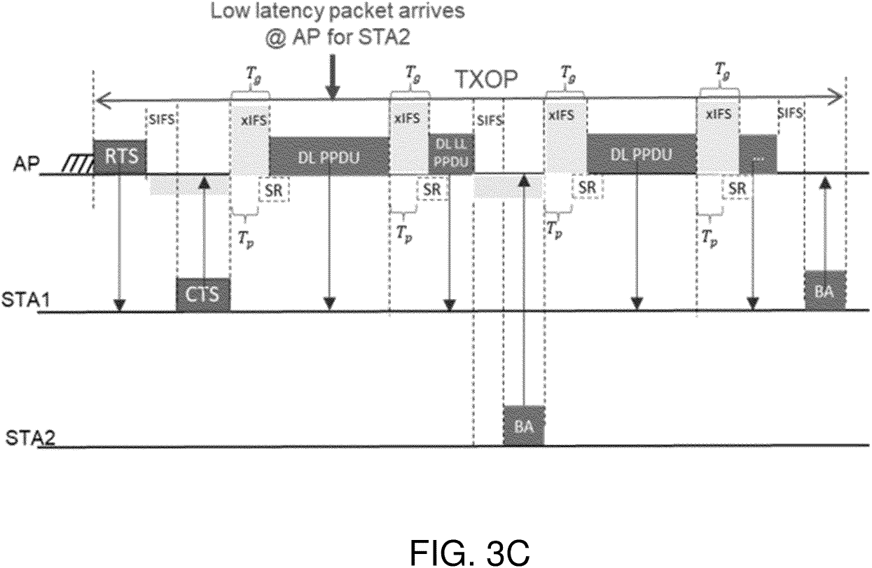

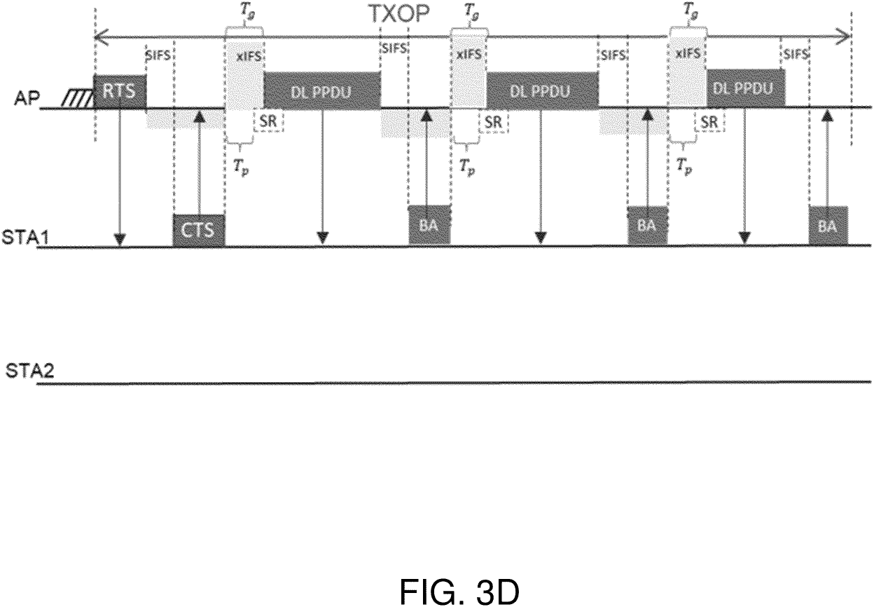

FIGS. 3A-3D depict illustrative schematic diagrams for low latency preemption, in accordance with one or more example embodiments of the present disclosure.

In one or more embodiments, a low latency preemption system may work for the case when the AP is the TXOP holder and use the TXOP for downlink (DL) PPDU transmission or UL trigger based PPDU transmission.

In some embodiments, a low latency preemption system can govern the behaviors of the AP and non-AP STAs. The AP STA can indicate its support for preemption during the beacon or association procedure. It can also indicate whether the current TXOP is preemptable or not in the first control frame it sends. Additionally, the AP STA can select and indicate which non-AP STAs are allowed to do preemption, and under which conditions. Furthermore, the AP STA can define the maximum PPDU length limitation. On the other hand, the non-AP STA can indicate its support for preemption during the association process. It can check whether the current TXOP is preemptable based on the first control frame sent by the AP STA. The non-AP STA can also check if it is allowed to do preemption, and when or under which conditions. Lastly, the non-AP STA may adhere to the maximum PPDU length limitation set by the AP STA. Overall, these behaviors help govern the preemption process and ensure that low latency transmission is facilitated while minimizing interference with other transmissions.

Referring to FIG. 3A, there is shown a downlink case, where an AP is sending segmented downlink traffic (e.g. DL PPDU).

As shown in FIG. 3A, a long TXOP DL transmission is divided into multiple DL PPDU transmissions with a fixed time gap T_{g}, such as a short inter-frame space (SIFS) or point coordination function IFS (PIFS), between the two continuous PPDU transmissions. The maximum length of each DL PPDU is designed based on the latency requirement of the LL application. An enhanced request to send (RTS) frame is transmitted and includes several indications. First, it indicates whether the current TXOP is preemptable or not, which is done by setting a preemption or suspend bit to 1 to indicate that the TXOP is preemptable and set to 0 to indicate that it is not preemptable. Second, the RTS frame indicates whether the first DL PPDU is preemptable or not. Similarly, a preemption or suspend bit may be set to 1 to indicate that the first DL PPDU is preemptable and set to 0 to indicate that it is not preemptable. Finally, any subsequent DL PPDU may also have that bit set to 1 or 0 to indicate whether the subsequent DL PPDU is preemptable or not. The enhanced RTS frame also indicates who or under which condition can do the preemption, such as a particular device that receives the RTS and/or the first DL PPDU. Upon reception of the enhanced RTS frame, if the non-AP STAs know the end of the enhanced CTS frame and have LL packet to be sent, they can send suspend request (SR) frame (this is synonymous with a preemption request (PR), which will be used interchangeably in this disclosure), it can be as short as one short training field (STF) or can be more if reliability/protection/identifier is needed, such as an NDP frame with receiver address only, or a null data packet Feedback Report (NFR) frame over multiple tone sets or NFR frame over multiple resource units (RUs), Tₚ time after the end of the enhanced CTS frame as shown in FIG. 3A. Note: the Tₚ time should be smaller than the time gap between the enhanced CTS frame and the first DL PPDU, Tₚ < T_{g}. For example, Tₚ=SIFS and T_{g}=PIFS.

Upon the detection of the STF, before the AP continues the next DL PPDU transmission, the AP may suspend the following DL PPDU transmission and continue to decode the SR from the LL STAs. If AP only receives an SR as STF without knowing who has sent the SR, SIFS time after the reception of the SR frame, it can send an NRFP frame to trigger the LL STAs to feedback the buffer status report for the low latency application. After that or the AP is able to receive the SR as NFR that may be sent from multiple LL STAs and know who has sent the NFR based on the predesigned tone set/ RU assignments among the LL STAs directly, the AP can send a trigger frame to trigger the LL STAs to send UL LL packet. The TF frame will set the preemption bit =0 to avoid the interruption of the following LL transmission. After the LL/BA exchange between the AP and the LL STA, the AP can resume the DL PPDU transmission or terminate the current TXOP and re-access the channel for a new TXOP.

xIFS time after the reception of the enhanced CTS frame, if the AP does not detect any STF frame, it will send the first DL PPDU as planned and indicate whether the next DL PPDU is preemptable or not. Upon the reception of the preamble of the DL PPDU, the LL STA including the receiver of the current DL PPDU can preempt the following DL PPDU, Tₚ time after the end of the current DL PPDU frame. The receiver of the current DL PPDU may preempt the next DL PPDU if it has UL LL packet to be sent to the AP or the packet error rate of the received DL PPDU is larger and needs the AP to adjust the MCS level to improve the transmission performance.

Upon the detection of the STF, the AP will suspend the following DL PPDU transmission as described above and FIG. 3B.

During the DL PPDU transmission, if the AP has a LL packet to be transmitted to a LL STA, it can transmit the LL packet in the next DL PPDU as normal PPDU but setting the acknowledged policy as an immediate response. After that, AP can either early terminate the current TXOP or resume the next DL PPDU transmission as shown in FIG. 3C.

SIFS time after the reception of the SR frame, the AP may decide to continue the next DL PPDU transmission with the preemption bit =0 and trigger the LL STAs SIFS time after the next DL PPDU transmission.

This scheme also works for the case when there is block acknowledgment (BA) for each DL PPDU as long as the AP indicates the length (time duration) of the following BA in each DL PPDU frame as shown in FIG. 3D.

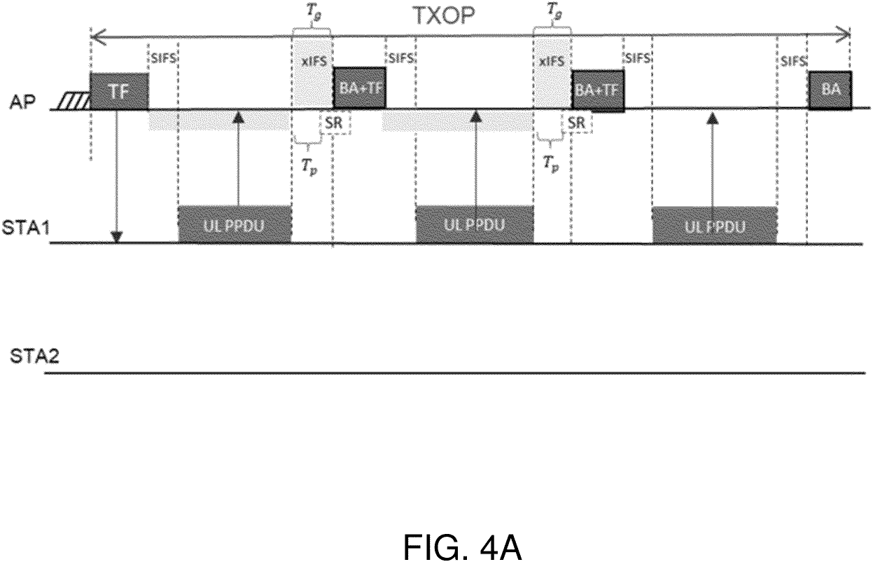

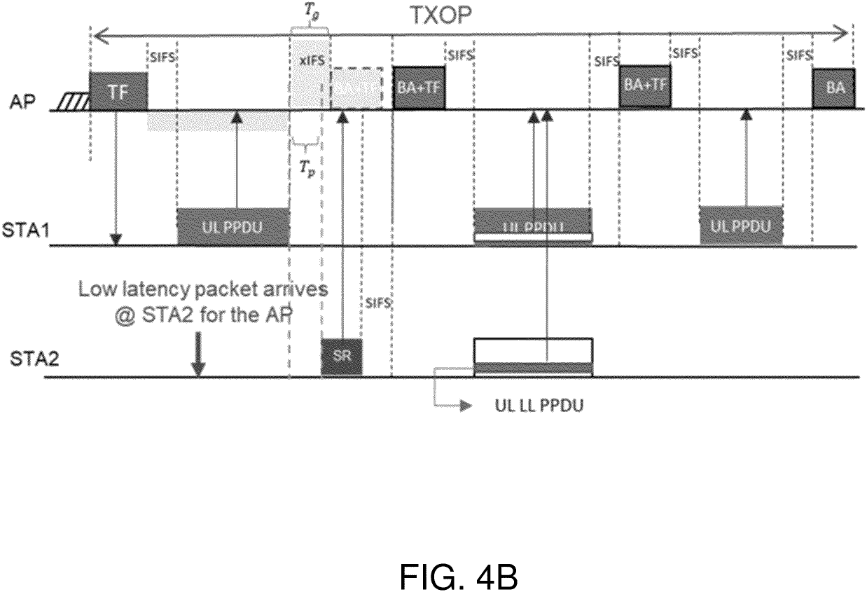

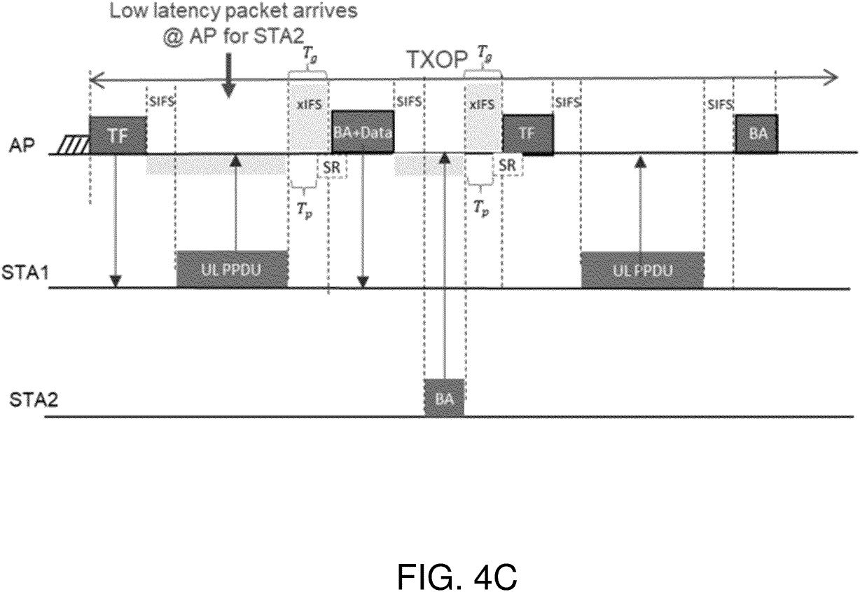

FIGS. 4A-4C depict illustrative schematic diagrams for low latency preemption, in accordance with one or more example embodiments of the present disclosure.

As shown in FIG. 4A, the long TXOP UL TB PPDU and BA exchange between the AP and the STA is divided into multiple PPDU/BA exchanges. To reduce the overhead, the BA for the previous UL PPDU and trigger frame for the next UL PPDU can be integrated in a single frame if needed. The time gap between the UL PPDU and the following aggregated BA and TF frame sent by the AP is set to be T_{g}. The time gap between the TF and the first UL PPDU and that between the BA+TF and the next UL PPDU is set to be SIFS. The maximum length of each UL PPDU/BA exchange will be designed based on the latency requirement of the LL application. The first TF frame will indicate:
Whether the current TXOP is preemptable by a device or not.
Which device or under which condition can do the preemption.

Then, both the first TF and following aggregated BA+TF frame will indicate whether the next BA+TF frame following the UL PPDU is preemptable or not.

Upon reception of the TF or BA+TF frame, if the LL transmitters know the end of the following UL PPDU frame and has LL packet to be sent, they can send SR frame, it can be as short as one STF or can be if reliability/protection/identifier is needed, such as an NDP frame with receiver address only, or an NFR frame over multiple tone sets or NFR frame over multiple RUs, Tₚ time after the end of the UL PPDU frame, where the Tₚ time should be smaller than the time gap between the UL PPDU frame and the aggregated BA+TF frame, Tₚ <T_{g}. For example, Tₚ=SIFS and T_{g}=PIFS.

As shown in FIG. 4B, upon the detection of the STF, the AP will suspend the following BA+TF transmission and continue to decode the SR from the LL STAs. If AP only receives an SR without knowing who sent the SR, SIFS time after the reception of the SR frame, it can send an aggregated BA and TF to acknowledge the reception status of the last UL PPDU and trigger the LL STAs to feedback on the buffer status report of the low latency application with NFRP and NFR exchange. Note: this part is not shown in FIG. 4B. After that or if the AP is able to receive the NFR that may be sent from multiple LL STAs and know who has sent the NFR based on the predesigned tone set or RU assignments among the LL STAs directly, the AP can assign RUs for the LL STAs to send UL LL packet, which will be indicated in the next aggregated BA+ TF frame. The TF frame may set the preemption bit =0 to avoid the interruption of the following LL transmission. After the LL+non-LL and BA exchange between the AP and LL STA + non-LL STAs, AP can resume the non-LL UL PPDU transmission or terminate the current TXOP and re-access the channel for a new TXOP.

In some embodiments, the AP can take additional measures to facilitate low latency preemption. For example, the AP can enable preemption over the last block acknowledgment (BA) within the TXOP if needed. Additionally, in the aggregated BA and Trigger Frame (TF) frame, the AP can trigger only uplink LL STAs to send uplink LL frames after the reception of the previous uplink PPDU. These measures can further improve the efficiency and effectiveness of the low latency preemption system by allowing the AP to release the channel as soon as possible for the transmission of LL frames. In certain embodiments, when the AP has an LL packet for another STA or the same STA during the TXOP, there are several options for the AP to transmit the packet. As shown in FIG. 4C, the AP can integrate the LL packet with the block acknowledgment (BA) or integrate it in the next aggregated BA and traffic flow (TF) frame. Alternatively, the AP can send the LL packet separately following the next BA sent to the non-LL STA. Once the LL packet is transmitted, the AP can either resume the uplink (UL) trigger based protocol data unit (PPDU) transmission after the downlink (DL) LL/BA exchange or early terminate the current TXOP and re-access the medium for a new TXOP.

In certain embodiments, after receiving the SR (or PR), the AP may choose to trigger the next UL PPDU transmission with the preemption bit set to 0, and then wait for a SIFS time before triggering the LL STAs with the preemption bit also set to 0. This behavior allows for efficient use of the medium and minimizes the likelihood of collisions or interference between transmissions from different STAs.

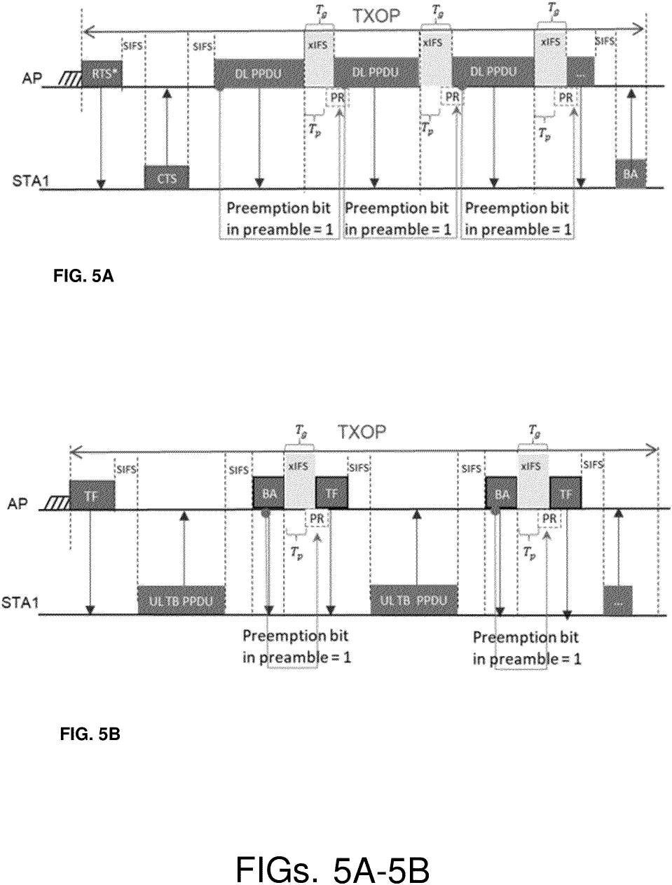

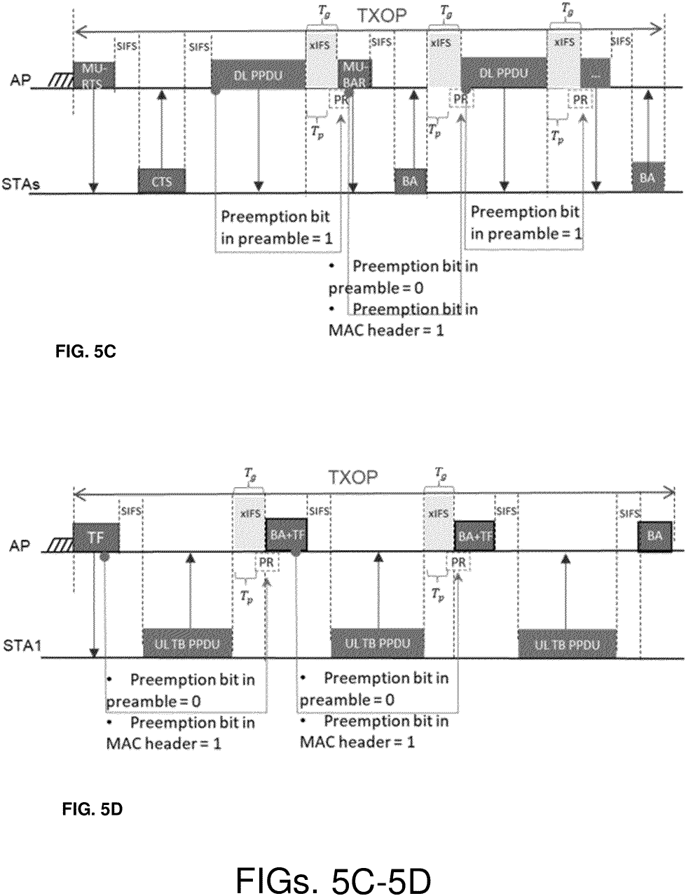

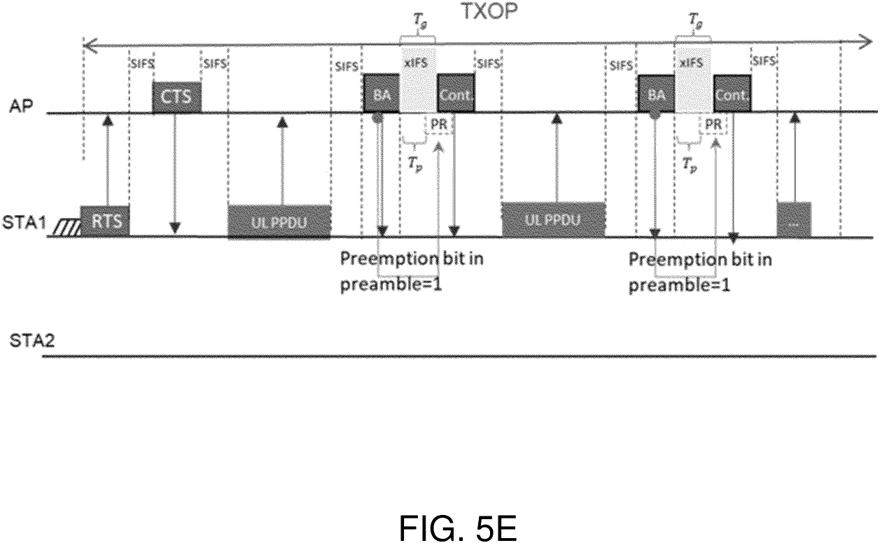

FIGS. 5A-5E depict illustrative schematic diagrams for low latency preemption, in accordance with one or more example embodiments of the present disclosure.

In one or more embodiments, a preemption indication system involves two levels of indication, the first being the TXOP preemption indication. This initial level is used to signal whether the current TXOP can be preempted or not. This information is communicated in the first control frame of the TXOP. The second level of preemption is known as the time gap preemption indication, which indicates the allowed time gap for preemption.

There are two methods for conveying this information. One approach is to use a single bit in the U-SIG or UHR-SIG of the current PPDU to indicate whether preemption is allowed or not T_{P} after the end of the PPDU transmitted by the AP. This method is used in DL burst PPDU transmission without immediate BA feedback (FIG. 5A) and UL TB PPDU transmission with immediate BA feedback (FIG. 5B).

The second approach involves using one bit in the MAC header to indicate whether preemption is allowed or not SIFS + duration (e.g. UL TB data/BA PPDU length in common info field) + Tp after the end of the current PPDU. This is used in cases such as DL MU PPDU with MU-BAR/BA (FIG. 5C) and TB UL PPDU with integrated BA and TF (FIG. 5D). It is important to note that the preemption bit in the preamble needs to be 0.

The low latency preemption system is designed to support a specific scenario in which the STA is the holder of the TXOP and is using it for UL SU PPDU transmission. In this case, the system allows for preemption to occur with low latency. In one or more embodiments, a low latency preemption system may facilitate that when a non-AP STA is associated with an AP STA, non-AP STA may adhere to certain behaviors. Firstly, it may specify whether it supports preemption during the association process. Additionally, it may indicate whether the current TXOP is preemptable or not, which is done in the first control frame it sends, such as the RTS frame. The non-AP STA may follow the maximum PPDU length limitation set by the AP STA. When transmitting multiple UL PPDU within the TXOP, the non-AP STA may initiate the transmission upon receiving the short control frame from the AP marked as, for example, “cont.” frame. Lastly, the non-AP STA may support the AP STA in taking over the TXOP for DL or UL transmission with other STAs.

In one or more embodiments, a low latency preemption system may facilitate that the AP STA has several behaviors that it can exhibit. Firstly, it may indicate whether it supports preemption or not in either the beacon or association process. It may then select and indicate which non-AP STAs are allowed to perform preemption. To allow UL STA to continue the next PPDU transmission or not, the AP STA may send a short control frame that could be, for example, marked as “cont.” frame in FIG. 5E. The AP STA may also indicate when or under which conditions the non-AP STA is allowed to perform preemption. Additionally, the AP STA may define the maximum PPDU length limitation. It is important to note that the AP STA may take over a non-AP STA’s TXOP and initiate DL or UL transmission with other STAs. If the PR frame can be a short common waveform, which can be transmitted within Tg time before the next PPDU, it can be sent during any time gap following the PPDU sent by the AP. If preemption within the TXOP is allowed, then the AP may schedule the LL packet transmission in the rest of the TXOP.

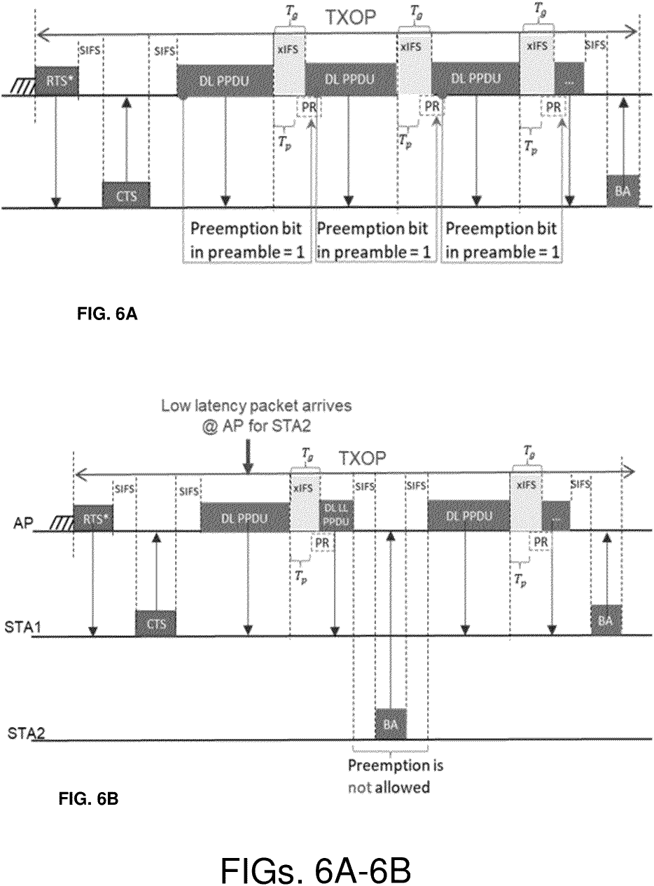

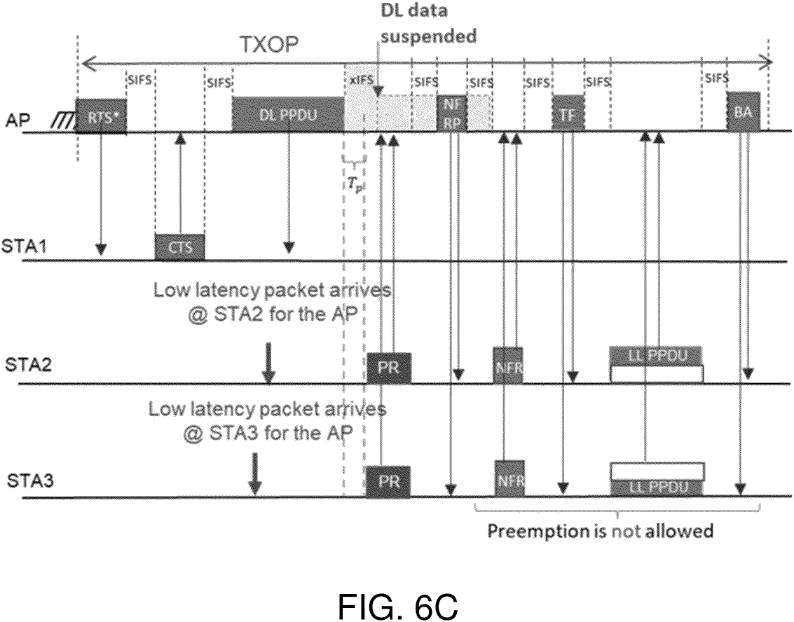

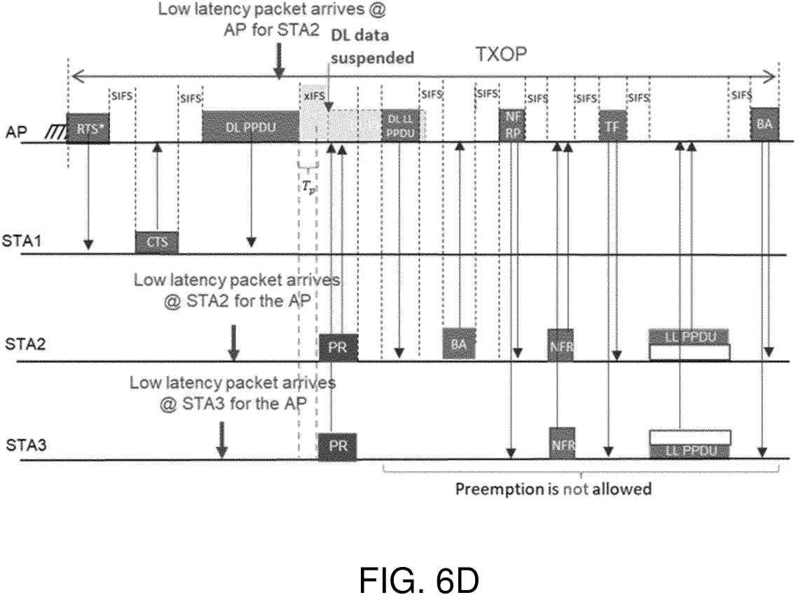

FIGS. 6A-6D depict illustrative schematic diagrams for low latency preemption, in accordance with one or more example embodiments of the present disclosure.

In one or more embodiments, several examples here illustrate the downlink case with the AP serving as the TXOP holder and preemption occurring. FIGS. 6A-6D depict different scenarios in which preemption occurs in the DL case. Notably, it is the decision of the AP when to send the DL LL packet or trigger the UL STAs to send UL LL packet, and how to schedule the DL LL packet transmission and UL LL packet transmission when the AP has received the PR frame while it has DL LL packet to send simultaneously (e.g., FIG. 6D). Such flexibility in scheduling allows for efficient use of available resources and enhanced system performance.

Referring to FIG. 6A, there is shown a DL case without preemption.

Referring to FIG. 6B, there is shown DL TXOP with DL low latency packet to send.

Referring to FIG. 6C, there is shown DL TXOP with UL LL packets from multiple UL STAs.

Referring to FIG. 6D, there is shown DL TXOP with both DL LL packet to send and UL LL packets from multiple UL STAs.

It is understood that the above descriptions are for purposes of illustration and are not meant to be limiting.

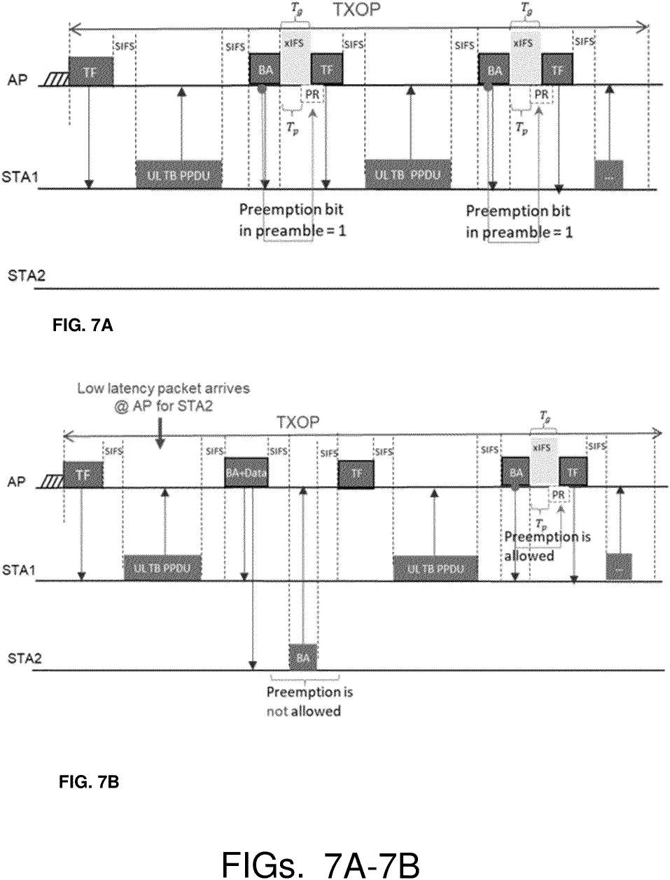

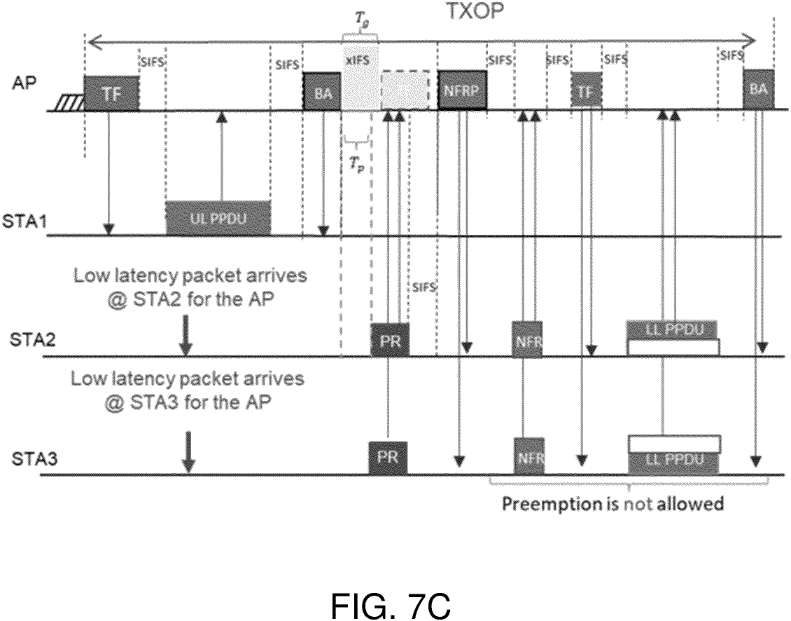

FIGS. 7A-7C depict illustrative schematic diagrams for low latency preemption, in accordance with one or more example embodiments of the present disclosure.

In one or more embodiments, in the UL case with the AP as the TXOP holder, several examples are shown in FIGS. 7A-7C when preemption occurs. It should be noted that the timing of the DL LL packet transmission or triggering of UL LL packet transmission from other STAs is at the discretion of the AP.

Referring to FIG. 7A, there is shown UL TXOP when there is no preemption.

Deferring to FIG. 7B, there is shown UL TXOP with DL LL packet to send.

Referring to FIG. 7C, there is shown UL TXOP with UL LL packet from another STA.

It is understood that the above descriptions are for purposes of illustration and are not meant to be limiting.

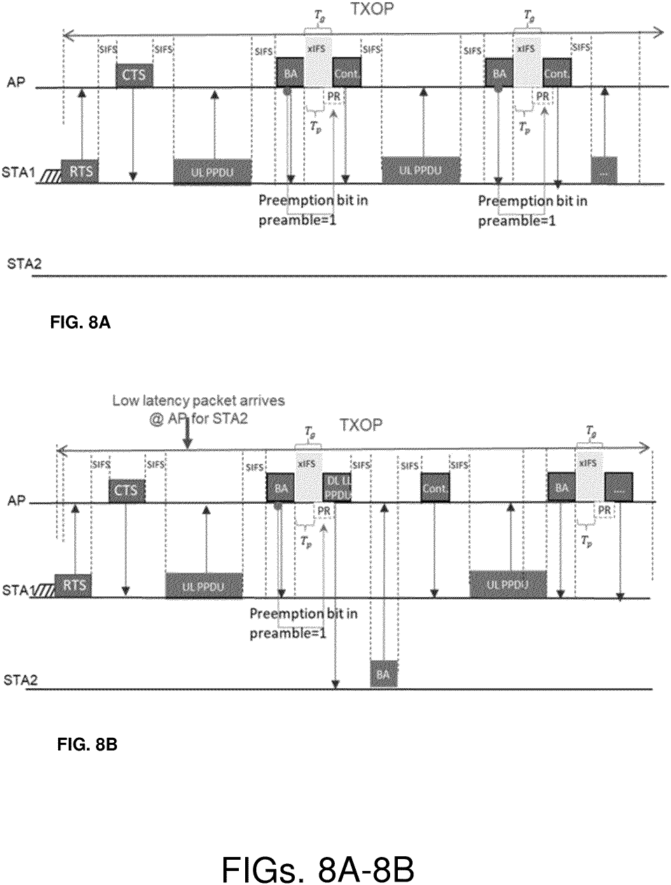

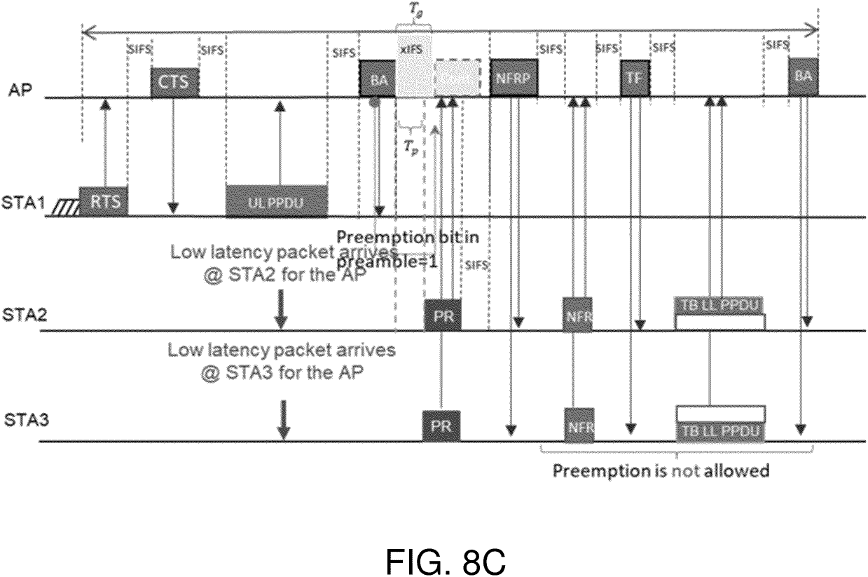

FIGS. 8A-8C depict illustrative schematic diagrams for low latency preemption, in accordance with one or more example embodiments of the present disclosure.

In one or more embodiments, several examples are disclosed in FIGS. 8A-8C that relate to the uplink SU case with an STA as the TXOP holder when preemption is involved. It is noteworthy that the AP has discretion over whether to trigger UL TB PPDU transmission from other STAs or take over the TXOP for DL PPDU transmission to other STAs, or inform the TXOP holder to continue the next UL SU PPDU transmission. In the event that the AP has determined to take over the TXOP, this information can be communicated to the STA in the BA frame. Conversely, if the AP has decided to allow the TXOP holder to continue the next UL SU PPDU transmission, it will send the “cont.” frame T_{g} time after the end of the BA frame. Upon receipt of a preemption request (PR), it is within the AP’s discretion as to when to send the DL LL packet or when to trigger other UL STAs to send UL LL packets. The examples in FIGS. 8A-8C serve to illustrate the various scenarios that may arise during the uplink SU case with an STA as the TXOP holder in the presence of preemption.

Referring to FIG. 8A, there is shown UL TXOP with STA as the TXOP without preemption.

Referring to FIG. 8B, there is shown UL TXOP with STA as the TXOP with DL LL packet to another STA.

Referring to FIG. 8C, there is shown UL TXOP with STA as the TXOP with UL LL packet from other STAs.

It is understood that the above descriptions are for purposes of illustration and are not meant to be limiting.

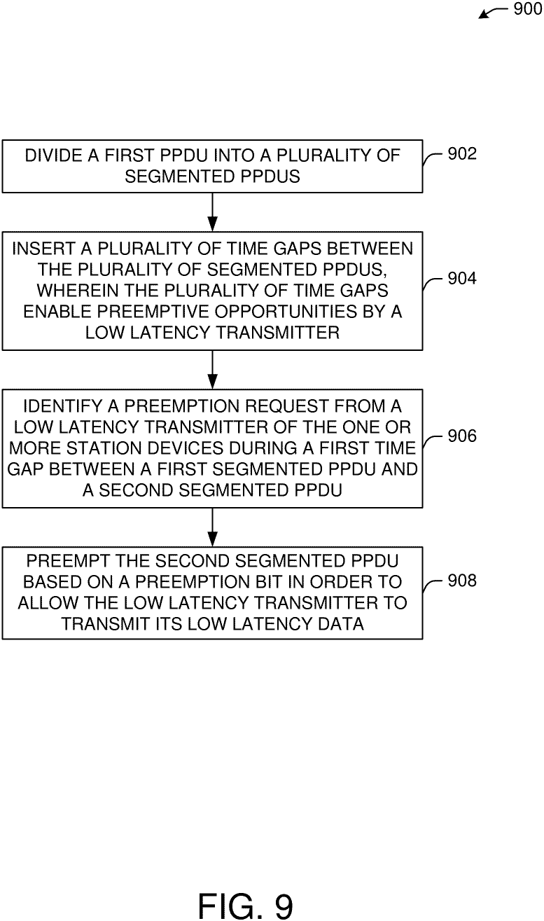

FIG. 9 illustrates a flow diagram of a process 900 for a low latency preemption system, in accordance with one or more example embodiments of the present disclosure.

In one or more embodiments, a low latency preemption system relates to preemptive communication in wireless networks, and more specifically, to a method and device for dividing a first PPDU into a plurality of segmented PPDUs, inserting time gaps between the segmented PPDUs, enabling preemptive opportunities by a low latency transmitter, sending the segmented PPDUs to one or more station devices, identifying a preemption request during a time gap before a first segmented PPDU, and preempting the first segmented PPDU to allow the low latency transmitter to transmit its low latency data.

At block 902, a device (e.g., the user device(s) 120 and/or the AP 102 of FIG. 1 and/or the low latency preemption device 1119 of FIG. 11) may divide a first PPDU into a plurality of segmented PPDUs, each having a respective Preemption Bit set to indicate preemptability.

At block 904, the device may insert a plurality of time gaps between the segmented PPDUs. The time gaps allow preemptive opportunities for a low latency transmitter, such as an AP or an STA.

At block 906, the device may send the segmented PPDUs to one or more station devices.

At block 908, the device may identify a preemption request during a first time gap before a first segmented PPDU. The preemption request may be generated by the low latency transmitter, indicating its higher priority data.

At block 910, the device may preempt the first segmented PPDU if the Preemption Bit is set to 1 and the low latency data has a higher priority than the first segmented PPDU.

The device described herein enables preemptive communication in wireless networks by dividing a PPDU into segmented PPDUs with preemption bits, inserting time gaps, and preempting PPDUs when necessary to allow low latency data to be transmitted. The device can be implemented in various wireless networks, including but not limited to WiFi, cellular, and satellite networks.

It is understood that the above descriptions are for purposes of illustration and are not meant to be limiting.

FIG. 10 shows a functional diagram of an exemplary communication station 1000, in accordance with one or more example embodiments of the present disclosure. In one embodiment, FIG. 10 illustrates a functional block diagram of a communication station that may be suitable for use as an AP 102 (FIG. 1) or a user device 120 (FIG. 1) in accordance with some embodiments. The communication station 1000 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1000 may include communications circuitry 1002 and a transceiver 1010 for transmitting and receiving signals to and from other communication stations using one or more antennas 1001. The communications circuitry 1002 may include circuitry that can operate the physical layer (PHY) communications and/or medium access control (MAC) communications for controlling access to the wireless medium, and/or any other communications layers for transmitting and receiving signals. The communication station 1000 may also include processing circuitry 1006 and memory 1008 arranged to perform the operations described herein. In some embodiments, the communications circuitry 1002 and the processing circuitry 1006 may be configured to perform operations detailed in the above figures, diagrams, and flows.

In accordance with some embodiments, the communications circuitry 1002 may be arranged to contend for a wireless medium and configure frames or packets for communicating over the wireless medium. The communications circuitry 1002 may be arranged to transmit and receive signals. The communications circuitry 1002 may also include circuitry for modulation/demodulation, upconversion/downconversion, filtering, amplification, etc. In some embodiments, the processing circuitry 1006 of the communication station 1000 may include one or more processors. In other embodiments, two or more antennas 1001 may be coupled to the communications circuitry 1002 arranged for sending and receiving signals. The memory 1008 may store information for configuring the processing circuitry 1006 to perform operations for configuring and transmitting message frames and performing the various operations described herein. The memory 1008 may include any type of memory, including non-transitory memory, for storing information in a form readable by a machine (e.g., a computer). For example, the memory 1008 may include a computer-readable storage device, read-only memory (ROM), random-access memory (RAM), magnetic disk storage media, optical storage media, flash-memory devices and other storage devices and media.

In some embodiments, the communication station 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1000 may include one or more antennas 1001. The antennas 1001 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1000 may include one or more of a keyboard, a display, a non-volatile memory port, multiple antennas, a graphics processor, an application processor, speakers, and other mobile device elements. The display may be an LCD screen including a touch screen.

Although the communication station 1000 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device.

FIG. 11 illustrates a block diagram of an example of a machine 1100 or system upon which any one or more of the techniques (e.g., methodologies) discussed herein may be performed. In other embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environments. The machine 1100 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a power management device 1132, a graphics display device 1110, an alphanumeric input device 1112 (e.g., a keyboard), and a user interface (UI) navigation device 1114 (e.g., a mouse). In an example, the graphics display device 1110, alphanumeric input device 1112, and UI navigation device 1114 may be a touch screen display. The machine 1100 may additionally include a storage device (i.e., drive unit) 1116, a signal generation device 1118 (e.g., a speaker), a low latency preemption device 1119, a network interface device/transceiver 1120 coupled to antenna(s) 1130, and one or more sensors 1128, such as a global positioning system (GPS) sensor, a compass, an accelerometer, or other sensor. The machine 1100 may include an output controller 1134, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1102 for generation and processing of the baseband signals and for controlling operations of the main memory 1104, the storage device 1116, and/or the low latency preemption device 1119. The baseband processor may be provided on a single radio card, a single chip, or an integrated circuit (IC).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within the static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

The low latency preemption device 1119 may carry out or perform any of the operations and processes (e.g., process 900) described and shown above.

It is understood that the above are only a subset of what the low latency preemption device 1119 may be configured to perform and that other functions included throughout this disclosure may also be performed by the low latency preemption device 1119.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD- ROM disks.

The instructions 1124 may further be transmitted or received over a communications network 1126 using a transmission medium via the network interface device/transceiver 1120 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1120 may include one or more physical jacks (e.g., Ethernet, coaxial, or phone jacks) or one or more antennas to connect to the communications network 1126. In an example, the network interface device/transceiver 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1100 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

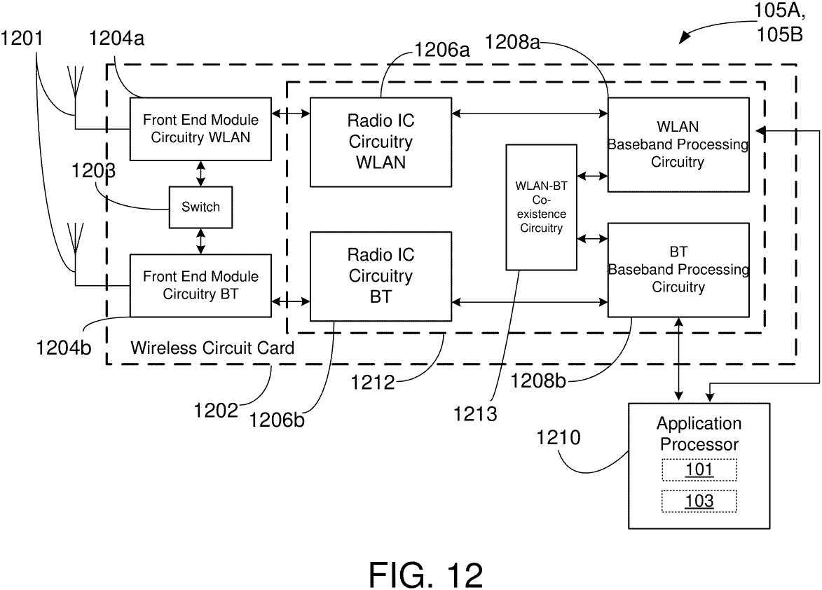

FIG. 12 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1204a-b, radio IC circuitry 1206a-b and baseband processing circuitry 1208a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1204a-b may include a WLAN or Wi-Fi FEM circuitry 1204a and a Bluetooth (BT) FEM circuitry 1204b. The WLAN FEM circuitry 1204a may include a receive signal path comprising circuitry configured to operate on WLAN RF signals received from one or more antennas 1201, to amplify the received signals and to provide the amplified versions of the received signals to the WLAN radio IC circuitry 1206a for further processing. The BT FEM circuitry 1204b may include a receive signal path which may include circuitry configured to operate on BT RF signals received from one or more antennas 1201, to amplify the received signals and to provide the amplified versions of the received signals to the BT radio IC circuitry 1206b for further processing. FEM circuitry 1204a may also include a transmit signal path which may include circuitry configured to amplify WLAN signals provided by the radio IC circuitry 1206a for wireless transmission by one or more of the antennas 1201. In addition, FEM circuitry 1204b may also include a transmit signal path which may include circuitry configured to amplify BT signals provided by the radio IC circuitry 1206b for wireless transmission by the one or more antennas. In the embodiment of FIG. 12, although FEM 1204a and FEM 1204b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1206a-b as shown may include WLAN radio IC circuitry 1206a and BT radio IC circuitry 1206b. The WLAN radio IC circuitry 1206a may include a receive signal path which may include circuitry to down-convert WLAN RF signals received from the FEM circuitry 1204a and provide baseband signals to WLAN baseband processing circuitry 1208a. BT radio IC circuitry 1206b may in turn include a receive signal path which may include circuitry to down-convert BT RF signals received from the FEM circuitry 1204b and provide baseband signals to BT baseband processing circuitry 1208b. WLAN radio IC circuitry 1206a may also include a transmit signal path which may include circuitry to up-convert WLAN baseband signals provided by the WLAN baseband processing circuitry 1208a and provide WLAN RF output signals to the FEM circuitry 1204a for subsequent wireless transmission by the one or more antennas 1201. BT radio IC circuitry 1206b may also include a transmit signal path which may include circuitry to up-convert BT baseband signals provided by the BT baseband processing circuitry 1208b and provide BT RF output signals to the FEM circuitry 1204b for subsequent wireless transmission by the one or more antennas 1201. In the embodiment of FIG. 12, although radio IC circuitries 1206a and 1206b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 1208a-b may include a WLAN baseband processing circuitry 1208a and a BT baseband processing circuitry 1208b. The WLAN baseband processing circuitry 1208a may include a memory, such as, for example, a set of RAM arrays in a Fast Fourier Transform or Inverse Fast Fourier Transform block (not shown) of the WLAN baseband processing circuitry 1208a. Each of the WLAN baseband circuitry 1208a and the BT baseband circuitry 1208b may further include one or more processors and control logic to process the signals received from the corresponding WLAN or BT receive signal path of the radio IC circuitry 1206a-b, and to also generate corresponding WLAN or BT baseband signals for the transmit signal path of the radio IC circuitry 1206a-b. Each of the baseband processing circuitries 1208a and 1208b may further include physical layer (PHY) and medium access control layer (MAC) circuitry, and may further interface with a device for generation and processing of the baseband signals and for controlling operations of the radio IC circuitry 1206a-b.

Referring still to FIG. 12, according to the shown embodiment, WLAN-BT coexistence circuitry 1213 may include logic providing an interface between the WLAN baseband circuitry 1208a and the BT baseband circuitry 1208b to enable use cases requiring WLAN and BT coexistence. In addition, a switch 1203 may be provided between the WLAN FEM circuitry 1204a and the BT FEM circuitry 1204b to allow switching between the WLAN and BT radios according to application needs. In addition, although the antennas 1201 are depicted as being respectively connected to the WLAN FEM circuitry 1204a and the BT FEM circuitry 1204b, embodiments include within their scope the sharing of one or more antennas as between the WLAN and BT FEMs, or the provision of more than one antenna connected to each of FEM 1204a or 1204b.

In some embodiments, the front-end module circuitry 1204a-b, the radio IC circuitry 1206a-b, and baseband processing circuitry 1208a-b may be provided on a single radio card, such as wireless radio card 1202. In some other embodiments, the one or more antennas 1201, the FEM circuitry 1204a-b and the radio IC circuitry 1206a-b may be provided on a single radio card. In some other embodiments, the radio IC circuitry 1206a-b and the baseband processing circuitry 1208a-b may be provided on a single chip or integrated circuit (IC), such as IC 1212.

In some embodiments, the wireless radio card 1202 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1208b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

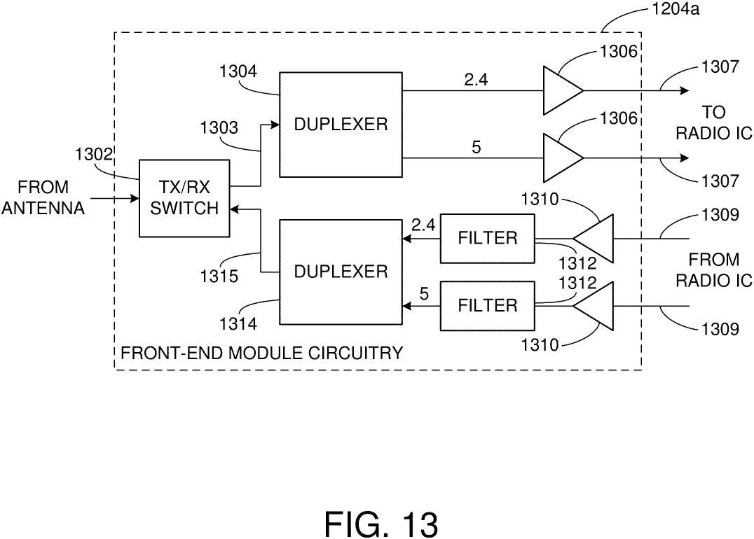

FIG. 13 illustrates WLAN FEM circuitry 1204a in accordance with some embodiments. Although the example of FIG. 13 is described in conjunction with the WLAN FEM circuitry 1204a, the example of FIG. 13 may be described in conjunction with the example BT FEM circuitry 1204b (FIG. 12), although other circuitry configurations may also be suitable.

In some embodiments, the FEM circuitry 1204a may include a TX/RX switch 1302 to switch between transmit mode and receive mode operation. The FEM circuitry 1204a may include a receive signal path and a transmit signal path. The receive signal path of the FEM circuitry 1204a may include a low-noise amplifier (LNA) 1306 to amplify received RF signals 1303 and provide the amplified received RF signals 1307 as an output (e.g., to the radio IC circuitry 1206a-b (FIG. 12)). The transmit signal path of the circuitry 1204a may include a power amplifier (PA) to amplify input RF signals 1309 (e.g., provided by the radio IC circuitry 1206a-b), and one or more filters 1312, such as band-pass filters (BPFs), low-pass filters (LPFs) or other types of filters, to generate RF signals 1315 for subsequent transmission (e.g., by one or more of the antennas 1201 (FIG. 12)) via an example duplexer 1314.

In some dual-mode embodiments for Wi-Fi communication, the FEM circuitry 1204a may be configured to operate in either the 2.4 GHz frequency spectrum or the 5 GHz frequency spectrum. In these embodiments, the receive signal path of the FEM circuitry 1204a may include a receive signal path duplexer 1304 to separate the signals from each spectrum as well as provide a separate LNA 1306 for each spectrum as shown. In these embodiments, the transmit signal path of the FEM circuitry 1204a may also include a power amplifier 1310 and a filter 1312, such as a BPF, an LPF or another type of filter for each frequency spectrum and a transmit signal path duplexer 1304 to provide the signals of one of the different spectrums onto a single transmit path for subsequent transmission by the one or more of the antennas 1201 (FIG. 12). In some embodiments, BT communications may utilize the 2.4 GHz signal paths and may utilize the same FEM circuitry 1204a as the one used for WLAN communications.

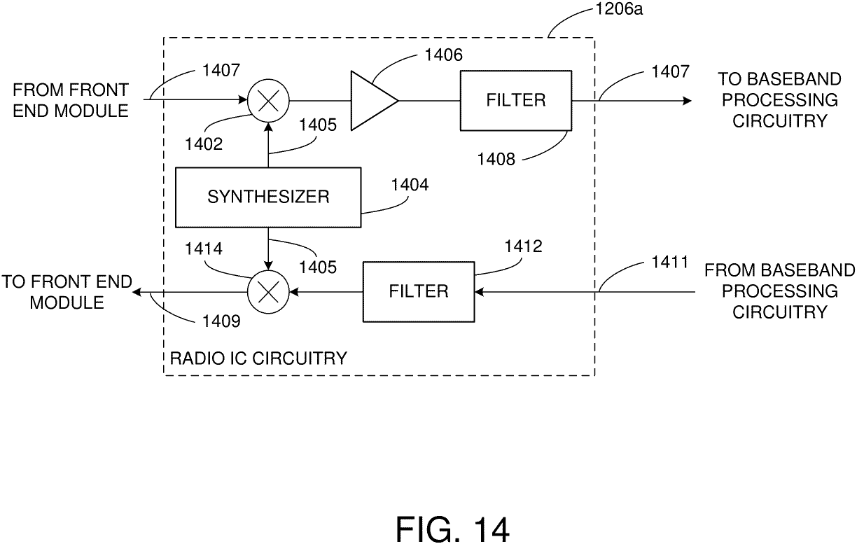

FIG. 14 illustrates radio IC circuitry 1206a in accordance with some embodiments. The radio IC circuitry 1206a is one example of circuitry that may be suitable for use as the WLAN or BT radio IC circuitry 1206a/1206b (FIG. 12), although other circuitry configurations may also be suitable. Alternatively, the example of FIG. 14 may be described in conjunction with the example BT radio IC circuitry 1206b.

In some embodiments, the radio IC circuitry 1206a may include a receive signal path and a transmit signal path. The receive signal path of the radio IC circuitry 1206a may include at least mixer circuitry 1402, such as, for example, down-conversion mixer circuitry, amplifier circuitry 1406 and filter circuitry 1408. The transmit signal path of the radio IC circuitry 1206a may include at least filter circuitry 1412 and mixer circuitry 1414, such as, for example, up-conversion mixer circuitry. Radio IC circuitry 1206a may also include synthesizer circuitry 1404 for synthesizing a frequency 1405 for use by the mixer circuitry 1402 and the mixer circuitry 1414. The mixer circuitry 1402 and/or 1414 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 14 illustrates only a simplified version of a radio IC circuitry, and may include, although not shown, embodiments where each of the depicted circuitries may include more than one component. For instance, mixer circuitry 1414 may each include one or more mixers, and filter circuitries 1408 and/or 1412 may each include one or more filters, such as one or more BPFs and/or LPFs according to application needs. For example, when mixer circuitries are of the direct-conversion type, they may each include two or more mixers.

In some embodiments, mixer circuitry 1402 may be configured to down-convert RF signals 1307 received from the FEM circuitry 1204a-b (FIG. 12) based on the synthesized frequency 1405 provided by synthesizer circuitry 1404. The amplifier circuitry 1406 may be configured to amplify the down-converted signals and the filter circuitry 1408 may include an LPF configured to remove unwanted signals from the down-converted signals to generate output baseband signals 1407. Output baseband signals 1407 may be provided to the baseband processing circuitry 1208a-b (FIG. 12) for further processing. In some embodiments, the output baseband signals 1407 may be zero-frequency baseband signals, although this is not a requirement. In some embodiments, mixer circuitry 1402 may comprise passive mixers, although the scope of the embodiments is not limited in this respect.

In some embodiments, the mixer circuitry 1414 may be configured to up-convert input baseband signals 1411 based on the synthesized frequency 1405 provided by the synthesizer circuitry 1404 to generate RF output signals 1309 for the FEM circuitry 1204a-b. The baseband signals 1411 may be provided by the baseband processing circuitry 1208a-b and may be filtered by filter circuitry 1412. The filter circuitry 1412 may include an LPF or a BPF, although the scope of the embodiments is not limited in this respect.

In some embodiments, the mixer circuitry 1402 and the mixer circuitry 1414 may each include two or more mixers and may be arranged for quadrature down-conversion and/or up-conversion respectively with the help of synthesizer 1404. In some embodiments, the mixer circuitry 1402 and the mixer circuitry 1414 may each include two or more mixers each configured for image rejection (e.g., Hartley image rejection). In some embodiments, the mixer circuitry 1402 and the mixer circuitry 1414 may be arranged for direct down-conversion and/or direct up-conversion, respectively. In some embodiments, the mixer circuitry 1402 and the mixer circuitry 1414 may be configured for super-heterodyne operation, although this is not a requirement.

Mixer circuitry 1402 may comprise, according to one embodiment: quadrature passive mixers (e.g., for the in-phase (I) and quadrature phase (Q) paths). In such an embodiment, RF input signal 1307 from FIG. 14 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1405 of synthesizer 1404 (FIG. 14). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1307 (FIG. 13) may comprise a balanced signal, although the scope of the embodiments is not limited in this respect. The I and Q baseband output signals may be provided to low-noise amplifier, such as amplifier circuitry 1406 (FIG. 14) or to filter circuitry 1408 (FIG. 14).

In some embodiments, the output baseband signals 1407 and the input baseband signals 1411 may be analog baseband signals, although the scope of the embodiments is not limited in this respect. In some alternate embodiments, the output baseband signals 1407 and the input baseb and signals 1411 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1404 may be a fractional-N synthesizer or a fractional N/N+1 synthesizer, although the scope of the embodiments is not limited in this respect as other types of frequency synthesizers may be suitable. For example, synthesizer circuitry 1404 may be a delta-sigma synthesizer, a frequency multiplier, or a synthesizer comprising a phase-locked loop with a frequency divider. According to some embodiments, the synthesizer circuitry 1404 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 1404 may be provided by a voltage controlled oscillator (VCO), although that is not a requirement. A divider control input may further be provided by either the baseband processing circuitry 1208a-b (FIG. 12) depending on the desired output frequency 1405. In some embodiments, a divider control input (e.g., N) may be determined from a look-up table (e.g., within a Wi-Fi card) based on a channel number and a channel center frequency as determined or indicated by the example application processor 1210. The application processor 1210 may include, or otherwise be connected to, one of the example secure signal converter 101 or the example received signal converter 103 (e.g., depending on which device the example radio architecture is implemented in).

In some embodiments, synthesizer circuitry 1404 may be configured to generate a carrier frequency as the output frequency 1405, while in other embodiments, the output frequency 1405 may be a fraction of the carrier frequency (e.g., one-half the carrier frequency, one-third the carrier frequency). In some embodiments, the output frequency 1405 may be a LO frequency (fLO).

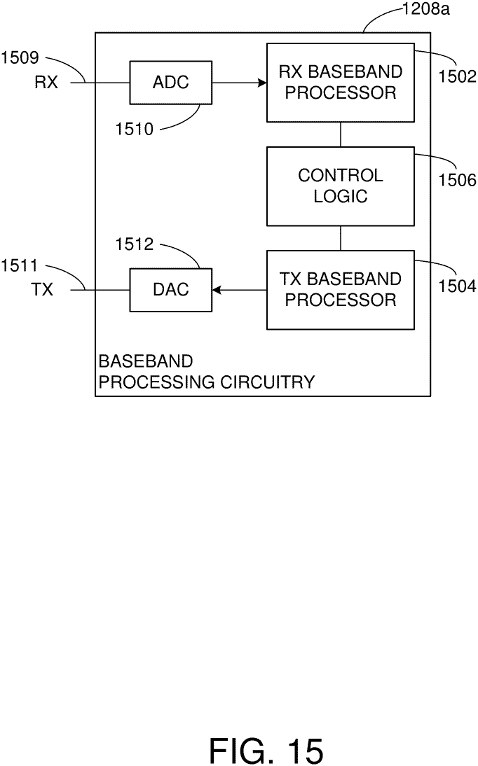

FIG. 15 illustrates a functional block diagram of baseband processing circuitry 1208a in accordance with some embodiments. The baseband processing circuitry 1208a is one example of circuitry that may be suitable for use as the baseband processing circuitry 1208a (FIG. 12), although other circuitry configurations may also be suitable. Alternatively, the example of FIG. 14 may be used to implement the example BT baseband processing circuitry 1208b of FIG. 12.

The baseband processing circuitry 1208a may include a receive baseband processor (RX BBP) 1502 for processing receive baseband signals 1409 provided by the radio IC circuitry 1206a-b (FIG. 12) and a transmit baseband processor (TX BBP) 1504 for generating transmit baseband signals 1411 for the radio IC circuitry 1206a-b. The baseband processing circuitry 1208a may also include control logic 1506 for coordinating the operations of the baseband processing circuitry 1208a.

In some embodiments (e.g., when analog baseband signals are exchanged between the baseband processing circuitry 1208a-b and the radio IC circuitry 1206a-b), the baseband processing circuitry 1208a may include ADC 1510 to convert analog baseband signals 1509 received from the radio IC circuitry 1206a-b to digital baseband signals for processing by the RX BBP 1502. In these embodiments, the baseband processing circuitry 1208a may also include DAC 1512 to convert digital baseband signals from the TX BBP 1504 to analog baseband signals 1511.

In some embodiments that communicate OFDM signals or OFDMA signals, such as through baseband processor 1208a, the transmit baseband processor 1504 may be configured to generate OFDM or OFDMA signals as appropriate for transmission by performing an inverse fast Fourier transform (IFFT). The receive baseband processor 1502 may be configured to process received OFDM signals or OFDMA signals by performing an FFT. In some embodiments, the receive baseband processor 1502 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 12, in some embodiments, the antennas 1201 (FIG. 12) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1201 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: divide a first PPDU into a plurality of segmented PPDUs; insert a plurality of time gaps between the plurality of segmented PPDUs, wherein the plurality of time gaps enable preemptive opportunities by a low latency transmitter; identify a preemption request from a low latency transmitter of the one or more station devices during a first time gap between a first segmented PPDU and a second segmented PPDU; and preempt the second segmented PPDU based on a preemption bit in order to allow the low latency transmitter to transmit its low latency data.

Example 2 may include the device of example 1 and/or some other example herein, wherein the first segmented PPDU comprises the preemption bit to indicate whether the second segmented PPDU may be preemptable, wherein the first segmented PPDU and the second segmented PPDU are consecutive.

Example 3 may include the device of example 1 and/or some other example herein, the preemption bit may be set to 1 to indicate that an associated segmented PPDU from the plurality of segmented PPDUs may be preemptable and set to 0 to indicate that the associated segmented PPDU from the plurality of segmented PPDUs may be not preemptable.

Example 4 may include the device of example 1 and/or some other example herein, wherein the preemption request may be generated by the low latency transmitter.

Example 5 may include the device of example 1 and/or some other example herein, wherein the low latency transmitter may be an access point (AP) or a station device (STA).

Example 6 may include the device of example 1 and/or some other example herein, wherein the processing circuitry may be further configured to determine a second time gap between the second segmented PPDU and a third segmented PPDU.

Example 7 may include the device of example 6 and/or some other example herein, wherein the processing circuitry may be further configured to: determine a time when a second preemption request may be received; determine the time may be greater than the second time gap; and prevent preemption of the third segmented PPDU.

Example 8 may include the device of example 1 and/or some other example herein, wherein the processing circuitry may be further configured to cause to send a request to send (RTS) frame a first station device, wherein the RTS frame comprises a transmit opportunity (TXOP) preemption bit.

Example 9 may include the device of example 2 and/or some other example herein, wherein the first time gap may be a short inter-frame space (SIFS) or point coordination function IFS (PIFS), between the first PPDU and the second PPDU.

Example 10 may include a non-transitory computer-readable medium storing computer-executable instructions which when executed by one or more processors result in performing operations comprising: dividing a first PPDU into a plurality of segmented PPDUs; inserting a plurality of time gaps between the plurality of segmented PPDUs, wherein the plurality of time gaps enable preemptive opportunities by a low latency transmitter; identifying a preemption request from a low latency transmitter of the one or more station devices during a first time gap between a first segmented PPDU and a second segmented PPDU; and preempting the second segmented PPDU based on a preemption bit in order to allow the low latency transmitter to transmit its low latency data.

Example 11 may include the non-transitory computer-readable medium of example 10 and/or some other example herein, wherein the first segmented PPDU comprises the preemption bit to indicate whether the second segmented PPDU may be preemptable, wherein the first segmented PPDU and the second segmented PPDU are consecutive.

Example 12 may include the non-transitory computer-readable medium of example 10 and/or some other example herein, the preemption bit may be set to 1 to indicate that an associated segmented PPDU from the plurality of segmented PPDUs may be preemptable and set to 0 to indicate that the associated segmented PPDU from the plurality of segmented PPDUs may be not preemptable.

Example 13 may include the non-transitory computer-readable medium of example 10 and/or some other example herein, wherein the preemption request may be generated by the low latency transmitter.

Example 14 may include the non-transitory computer-readable medium of example 10 and/or some other example herein, wherein the low latency transmitter may be an access point (AP) or a station device (STA).

Example 15 may include the non-transitory computer-readable medium of example 10 and/or some other example herein, wherein the operations further comprise determining a second time gap between the second segmented PPDU and a third segmented PPDU.

Example 16 may include the non-transitory computer-readable medium of example 15 and/or some other example herein, wherein the operations further comprise: determining a time when a second preemption request may be received; determining the time may be greater than the second time gap; and preventing preemption of the third segmented PPDU.

Example 17 may include the non-transitory computer-readable medium of example 10 and/or some other example herein, wherein the operations further comprise causing to send a request to send (RTS) frame a first station device, wherein the RTS frame comprises a transmit opportunity (TXOP) preemption bit.

Example 18 may include the non-transitory computer-readable medium of example 11 and/or some other example herein, wherein the first time gap may be a short inter-frame space (SIFS) or point coordination function IFS (PIFS), between the first PPDU and the second PPDU.

Example 19 may include a method comprising: dividing a first PPDU into a plurality of segmented PPDUs; inserting a plurality of time gaps between the plurality of segmented PPDUs, wherein the plurality of time gaps enable preemptive opportunities by a low latency transmitter; identifying a preemption request from a low latency transmitter of the one or more station devices during a first time gap between a first segmented PPDU and a second segmented PPDU; and preempting the first segmented PPDU based on a preemption bit in order to allow the low latency transmitter to transmit its low latency data.

Example 20 may include the method of example 19 and/or some other example herein, wherein the first segmented PPDU comprises the preemption bit to indicate whether the second segmented PPDU may be preemptable, wherein the first segmented PPDU and the second segmented PPDU are consecutive.

Example 21 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 22 may include an apparatus comprising logic, modules, and/or circuitry to perform one or more elements of a method described in or related to any of examples 1-20, or any other method or process described herein.

Example 23 may include a method, technique, or process as described in or related to any of examples 1-20, or portions or parts thereof.

Example 24 may include an apparatus comprising: one or more processors and one or more computer readable media comprising instructions that, when executed by the one or more processors, cause the one or more processors to perform the method, techniques, or process as described in or related to any of examples 1-20, or portions thereof.

Example 25 may include a method of communicating in a wireless network as shown and described herein.

Example 26 may include a system for providing wireless communication as shown and described herein.

Example 27 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
divide a first PPDU into a plurality of segmented PPDUs;
insert a plurality of time gaps between the plurality of segmented PPDUs, wherein the plurality of time gaps enable preemptive opportunities by a low latency transmitter;
identify a preemption request from a low latency transmitter of the one or more station devices during a first time gap between a first segmented PPDU and a second segmented PPDU; and
preempt the second segmented PPDU based on a preemption bit in order to allow the low latency transmitter to transmit its low latency data.

2. The device of claim 1, wherein the first segmented PPDU comprises the preemption bit to indicate whether the second segmented PPDU is preemptable, wherein the first segmented PPDU and the second segmented PPDU are consecutive.

3. The device of claim 1, the preemption bit is set to 1 to indicate that an associated segmented PPDU from the plurality of segmented PPDUs is preemptable and set to 0 to indicate that the associated segmented PPDU from the plurality of segmented PPDUs is not preemptable.

4. The device of claim 1, wherein the preemption request is generated by the low latency transmitter.

5. The device of claim 1, wherein the low latency transmitter is an access point (AP) or a station device (STA).

6. The device of claim 1, wherein the processing circuitry is further configured to determine a second time gap between the second segmented PPDU and a third segmented PPDU.

7. The device of claim 6, wherein the processing circuitry is further configured to:
determine a time when a second preemption request is received;
determine the time is greater than the second time gap; and
prevent preemption of the third segmented PPDU.

8. The device of claim 1, wherein the processing circuitry is further configured to cause to send a request to send (RTS) frame a first station device, wherein the RTS frame comprises a transmit opportunity (TXOP) preemption bit.

9. The device of claim 2, wherein the first time gap is a short inter-frame space (SIFS) or point coordination function IFS (PIFS), between the first PPDU and the second PPDU.

10. A non-transitory computer-readable medium storing computer-executable instructions which when executed by one or more processors result in performing operations comprising:
dividing a first PPDU into a plurality of segmented PPDUs;
inserting a plurality of time gaps between the plurality of segmented PPDUs, wherein the plurality of time gaps enable preemptive opportunities by a low latency transmitter;
identifying a preemption request from a low latency transmitter of the one or more station devices during a first time gap between a first segmented PPDU and a second segmented PPDU; and
preempting the second segmented PPDU based on a preemption bit in order to allow the low latency transmitter to transmit its low latency data.

11. The non-transitory computer-readable medium of claim 10, wherein the first segmented PPDU comprises the preemption bit to indicate whether the second segmented PPDU is preemptable, wherein the first segmented PPDU and the second segmented PPDU are consecutive.

12. The non-transitory computer-readable medium of claim 10, the preemption bit is set to 1 to indicate that an associated segmented PPDU from the plurality of segmented PPDUs is preemptable and set to 0 to indicate that the associated segmented PPDU from the plurality of segmented PPDUs is not preemptable.

13. The non-transitory computer-readable medium of claim 10, wherein the preemption request is generated by the low latency transmitter.

14. The non-transitory computer-readable medium of claim 10, wherein the low latency transmitter is an access point (AP) or a station device (STA).

15. The non-transitory computer-readable medium of claim 10, wherein the operations further comprise determining a second time gap between the second segmented PPDU and a third segmented PPDU.

16. The non-transitory computer-readable medium of claim 15, wherein the operations further comprise:
determining a time when a second preemption request is received;
determining the time is greater than the second time gap; and
preventing preemption of the third segmented PPDU.

17. The non-transitory computer-readable medium of claim 10, wherein the operations further comprise causing to send a request to send (RTS) frame a first station device, wherein the RTS frame comprises a transmit opportunity (TXOP) preemption bit.

18. The non-transitory computer-readable medium of claim 11, wherein the first time gap is a short inter-frame space (SIFS) or point coordination function IFS (PIFS), between the first PPDU and the second PPDU.

19. A method comprising:
dividing a first PPDU into a plurality of segmented PPDUs;
inserting a plurality of time gaps between the plurality of segmented PPDUs, wherein the plurality of time gaps enable preemptive opportunities by a low latency transmitter;
identifying a preemption request from a low latency transmitter of the one or more station devices during a first time gap between a first segmented PPDU and a second segmented PPDU; and
preempting the first segmented PPDU based on a preemption bit in order to allow the low latency transmitter to transmit its low latency data.

20. The method of claim 19, wherein the first segmented PPDU comprises the preemption bit to indicate whether the second segmented PPDU is preemptable, wherein the first segmented PPDU and the second segmented PPDU are consecutive.
